(19) United States
(12) Patent Application Publication
(10) Pub. No.: US 2023/0024321 A1
(43) Pub. Date: Jan. 26, 2023

(54) STATIC CHARGE REDUCTION DEVICE

(71) Applicant: ESD TECHNOLOGY CONSULTING & LICENSING CO., LTD, Shenzhen, Guangdong (CN)

(72) Inventor: Kek Hing Kow, Shenzhen, Guangdong (CN)

(21) Appl. No.: 17/778,408

(22) PCT Filed: Nov. 13, 2020
(86) PCT No.: PCT/CN2020/128616

§ 371 Date: May 19, 2022

(30) Foreign Application Priority Data
Nov. 20, 2019 (CN) PCT/CN2019/119661

(51) Int. Cl. H05F 1/00

(52) U.S. Cl. CPC H05F 1/00

(57) ABSTRACT

The present application relates to static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus; wherein the humid medium delivery apparatus, the conductive means and the target object are arranged successively along a delivery path of the humid medium, such that the humid medium is delivered through the humid medium delivery apparatus, the conductive means and the target object successively for static charge reduction. The discovery is surprising because no air ionizer has been used in neutralizing and cutting down the static charge

### TECHNICAL FIELD

The present application relates to static charge reduction technique, and more specific, to a static charge reduction device.

### BACKGROUND ART

It is a known fact in the ESD (Electro Static discharge) control industry that there are still notable limits and shortcomings in static charge reduction using air ionisation technology when come to moving web, insulating film or web-based processes especially in today's high-speed fast-output manufacturing environment.

Most of the current commercially available air ionization devices are not fast enough to neutralize those static charges lurking on the moving insulator web of polymeric nature.

D1 (CN 209627781U) has disclosed an equipment for removing static electricity of fabric finished products. However, in D1, the industrial humidifier 7 is arranged at the bottom of the device, and the generated humid air contact the fabric at first. In order not to affect the fabric quality, the humidity of the humid air should be carefully controlled. In additional, such technical solution is not proper for the targets which are sensitive to the humidity.

D2 (CN 104918397A) has disclosed a static eliminator configured by a static elimination head 200 and a humidified air generating part 300 connected through a meander-shaped hose 101, wherein the static elimination head 200 is provided with a power supply device 215, a plurality of static elimination needles 220 and two ground electrodes 230; wherein a high voltage is applied between the plurality of static elimination needles 220 and the ground electrode 230 by the power supply device 215 in the casing 210; thereby, corona discharge is generated between the plurality of static elimination needles 220 and the ground electrode 230. However, the arrangement and maintenance of the power supply device 215 is costly.

### SUMMARY OF INVENTION

### Technical Problem

Therefore, there is an industrial need to address the inadequacy and shortcomings of the current static charge reduction limitation. Further research and development works are needed to explore better alternative or solution to eliminate such current limitations cited above.

### Solution to Problem

### Technical Solution

According to one aspect, a static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus; wherein the humid medium delivery apparatus, the conductive means and the target object are arranged successively along a delivery path of the humid medium, such that the humid medium is delivered through the humid medium delivery apparatus, the conductive means and the target object successively for static charge reduction.

Optionally, the humid medium generator comprises a humid air generator for generating a humid air with a specified relative humidity, the humid medium delivery apparatus comprises a humid air delivery apparatus having an opening facing the target object for directing the humid air to the target object, and the conductive means comprises a mounting structure arranged in the opening and conductive elements arranged on the mounting structure, wherein the conductive elements are contacting the target object and connecting the grounded apparatus.

Optionally, the humid air delivery apparatus comprises an air nozzle with a flat mouth whose outer edge forms the opening facing the target object.

Optionally, the mounting structure comprises a strip arranged across the opening, and the conductive elements are metal threads attached to the strip and bended to form multiple small loops contacting the target object.

Optionally, two mounting slots are made at opposite inner sides of the opening and the strip is inserted into the mounting slots for attachment to the opening.

Optionally, the mounting structure comprises a roller arranged across the opening and the conductive elements are metal threads wrapping around the roller and in contact with the target object.

Optionally, the mounting structure further comprises two mounting slots made at opposite inner sides of the opening and a mounting axle of the roller is inserted into the mounting slots for attachment to the opening.

Optionally, the mounting structure comprises a strip arranged across the opening, and the conductive elements are soft metal sheets attached to the strip and contacting the target object.

Optionally, humid air delivery apparatus further comprises a delivery tubing for connecting the humid air generator and the flat mouth.

Optionally, the humid medium generator comprises a container filled with water, the humid medium delivery apparatus comprises a water delivery structure and a water delivery medium with one end wrapped up on the water delivery structure and other end contacting the conductive means, wherein a lower portion of the water delivery structure is immersed into the water and an upper portion of the water delivery structure is arranged above the water such that the water in the container is delivered through the water delivery medium, the conductive means and the target object successively for static charge reduction through capillary action.

Optionally, the water delivery structure is a cylindrical roll and a lower portion of the cylindrical roll is immersed into the water, the water delivery medium comprises a first water delivery medium portion wrapping up from the lower portion of the cylindrical roll to the upper portion of the cylindrical roll, a second water delivery medium portion wrapping the first water delivery medium on the upper portion of the cylindrical roll, and a third water delivery medium portion connecting the second water delivery medium portion and the conductive means.

Optionally, the conductive means comprises a horizontal mounting structure and conductive elements arranged on a lower edge of the horizontal mounting structure, and the third water delivery medium portion is attached on horizontal mounting structure such that the water can be delivered to the conductive elements.

Optionally, the conductive elements are metal threads bended to form multiple small loops contacting the target object, and the metal thread is incorporated with a tiny protective helical metal coil.

Optionally, the water delivery structure is further provided with a retractable mechanism for retracting the water delivery medium.

Optionally, the conductive means comprises two horizontal mounting structures arranged horizontally or in a titled manner such that conductive elements arranged on the lower edge of the two horizontal mounting structures contact the target object passing through horizontally or vertically, and the water delivery medium has a bilayer structure.

Optionally, further comprises a humid air generator for generating a humid air with a specified relative humidity and a humid medium delivery apparatus for blowing the humid air to the conductive means.

### Advantageous Effects of Invention

### Advantageous Effects

When humid medium with a specified relative humidity from the humid medium generator is delivered through the humid medium delivery apparatus, then the conductive means, and finally directed at the meeting point between the target object and the conductive means connecting the grounded apparatus, it is surprised to see the drop of more than 90% of the original static voltage after the target object was passed through and separated away from the conductive means. The discovery is surprising because no air ionizer has been used in neutralizing and cutting down the static charge.

### BRIEF DESCRIPTION OF DRAWINGS

### Description of Drawings

So as to further explain the application, an exemplary embodiment of the present application will be described with reference to the below drawings, wherein:

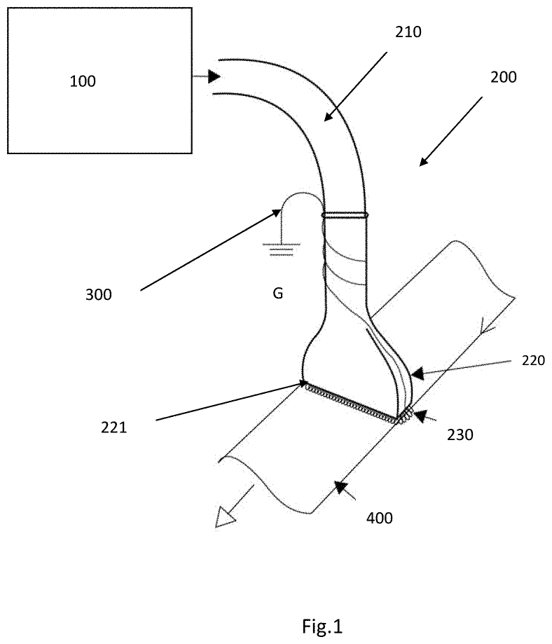

FIG. 1 is a diagram showing a static charge reduction device according to a first embodiment of the present application.

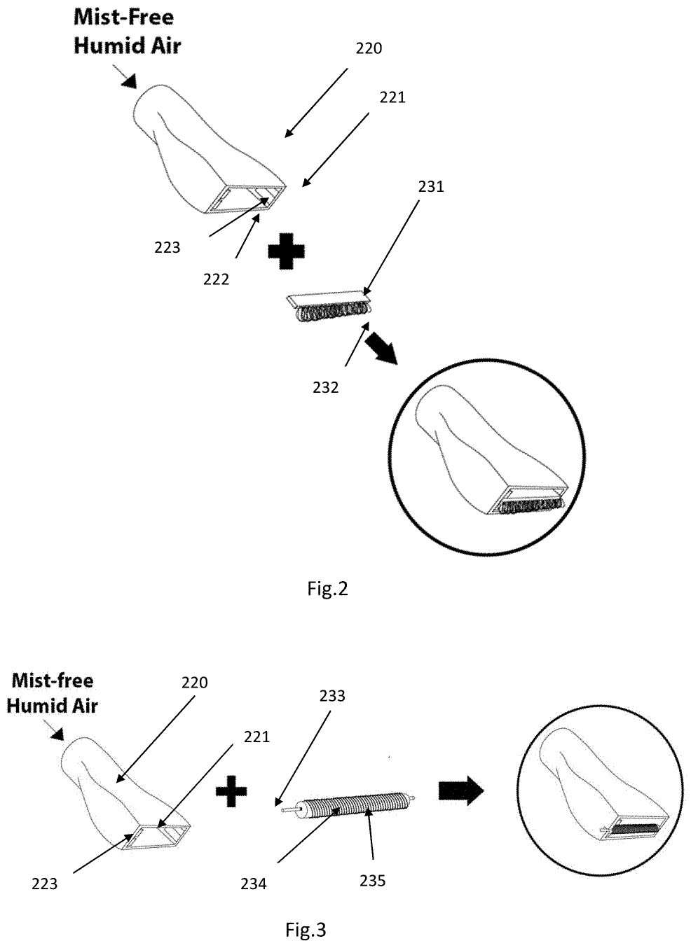

FIG. 2 is a decomposition diagram showing a humid air delivery apparatus according to a preferable embodiment of the present application.

FIG. 3 is a decomposition diagram showing a humid air delivery apparatus according to a further preferable embodiment of the present application.

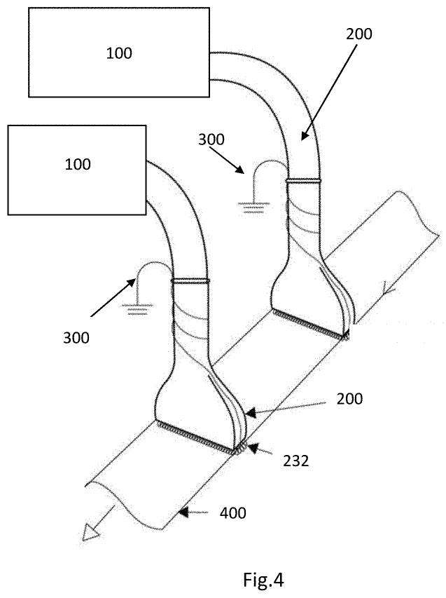

FIG. 4 is a diagram showing a static charge reduction device according to a second embodiment of the present application.

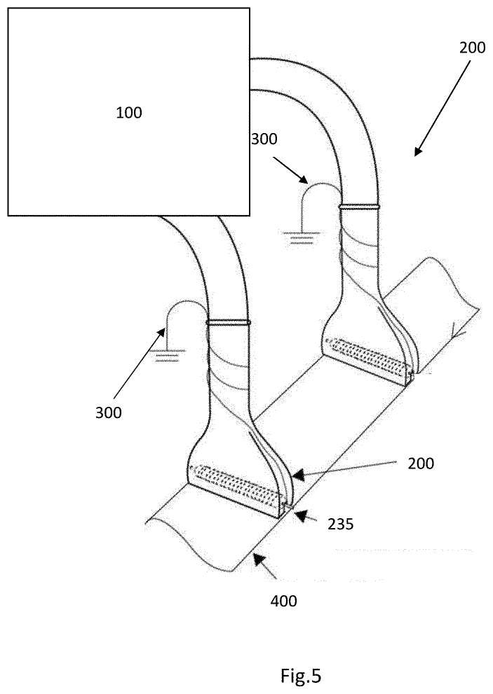

FIG. 5 is a diagram showing a static charge reduction device according to a third embodiment of the present application;

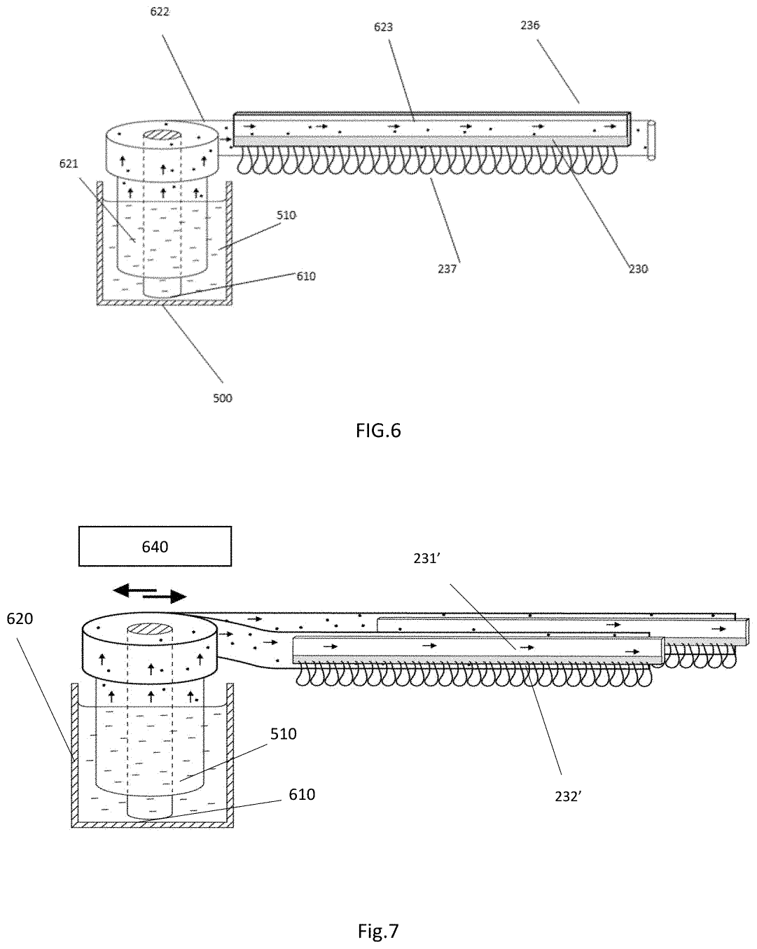

FIG. 6 is a diagram showing a static charge reduction device according to a fourth embodiment of the present application;

FIG. 7 is a diagram showing a static charge reduction device according to a fifth embodiment of the present application;

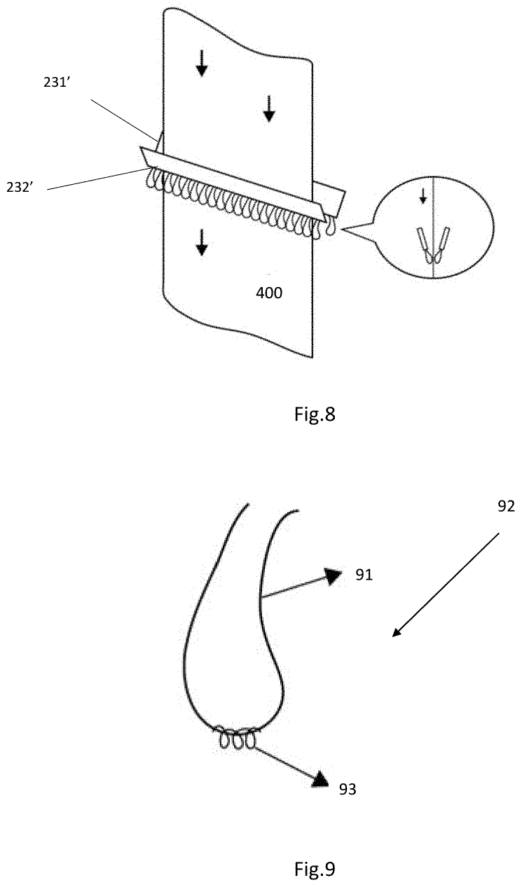

FIG. 8 is a diagram showing a static charge reduction device according to a sixth embodiment of the present application;

FIG. 9 is a diagram showing conductive elements according to preferable embodiment of the present application.

### BEST MODE FOR CARRYING OUT THE INVENTION

### Best Mode

These and other advantage, aspect and novel features of the present application, as well as details of an illustrated embodiment thereof will be more fully understood from the following description and drawings, while various embodiments of the present application are presented by way of examples only, not limitation.

The present application relates to a static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus; wherein the humid medium delivery apparatus, the conductive means and the target object are arranged successively along a delivery path of the humid medium, such that the humid medium is delivered through the humid medium delivery apparatus, the conductive means and the target object successively for static charge reduction. When humid medium with a specified relative humidity from the humid medium generator is delivered through the humid medium delivery apparatus, then the conductive means, and finally directed at the meeting point between the target object and the conductive means connecting the grounded apparatus, it is surprised to see the drop of more than 90% of the original static voltage after the target object was passed through and separated away from the conductive means. The discovery is surprising because no air ionizer has been used in neutralizing and cutting down the static charge.

FIG. 1 is a diagram showing a static charge reduction device according to a first embodiment of the present application. In the present application, the static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus.

In the embodiment referred by FIG. 1, the humid medium is humid air. Accordingly, the humid medium generator is a humid air generator 100 for generating a humid air with a specified relative humidity, while the humid medium delivery apparatus is a humid air delivery apparatus 200 for delivering the humid air to a target object 400. The grounded apparatus 300 connects the humid air delivery apparatus 200 and the ground G. The humid air delivery apparatus 200 has an opening 221 facing the target object 400 and the opening 221 is arranged with the conductive means 230 which both contacting the target object 400 and connecting the grounded apparatus 300.

In a preferable embodiment of the present application, the humid air generator 100 can be any controlled humid air supply which continually or any controlled humid air supplies which alternately outputting a humid air or humid airs with a specified relative humidity from 60% to 95%, preferably from 75% to 90%, and more preferably from 85%-90%. In more preferable embodiment, the specified relative humidity can be set as 75%, 85% or 95%. In a preferable embodiment of the present application, the humid air delivery apparatus 200 can have any shape as if it can be used for delivering humid air from the humid air generator 100 to the target object 400, and such humid air delivery apparatus 200 has an opening 221 facing the target object 400 for directing the humid air to the target object 400. For example, it can be a tubing with or without a nozzle, or a spraying nozzle with or without a connecting tubing.

In the more preferable embodiment of the present application as shown in FIG. 1, the humid air delivery apparatus 200 comprises an air nozzle 220 with a flat mouth 222 and a delivery tubing 210 for connecting the humid air generator 100 and the air nozzle 220. The outer edge of the flat mouth 222 forms the opening 221 facing the target object 400.

In a preferable embodiment of the present application, the conductive means 230 can be any conductive elements, such as metal sheets, threads, strips and the like which contacting the target object 400 and connecting the grounded apparatus 300. For example, the metal threads can be made up of many, many tiny wires forming a soft thread which may cut static charge reduction many times better than a standard metal wire. Of course, a standard metal wire can also be used which depends on the actual requirements.

In a further preferable embodiment, the conductive means may comprise a mounting structure affixed or attached to the opening 221 and conductive elements affixed or attached to the mounting structure, wherein the conductive elements are contacting the target object 400 and connecting the grounded apparatus 300. The mounting structure can be arranged in a removable or fixed manner at the opening 221. For example, it can be inserted into the opening 221 and fixed by screws, bolts or adhesive.

Preferably, the grounded apparatus 300 can be any grounded elements, such as a grounded cable with or without a grounded resistor connecting the conductive means 230. Moreover, the target object 400 can be any object whose static charges need to be reduced. The present application is especially useful for the target object with flat surfaces, such as a moving insulative film/web. Of course, the present application also can be used in the static charges reduction of other objects.

When a humid air with a specified relative humidity from the humid air generator is released at the opening of the humid air delivery apparatus and directed at the meeting point between the target object and the conductive means connecting the grounded apparatus, it is surprised to see the drop of more than 90% of the original static voltage after the target object was passed through and separated away from the conductive means. The discovery is surprising because no air ionizer has been used in neutralizing and cutting down the static charge and further reducing the static voltage.

It is not fully understood why such a big reduction in the static charges, probably one of the main reasons is as follows: highly dense water molecules at 60% RH or above on the surface of the target object provides an unusual favourable condition that “transforms” the surface to a higher level of “conductivity” for the drainage of static charge, when the target object is electrically connected to ground, while, it is a common knowledge that grounding of any static charge or static voltage that resides on an insulator is difficult when the air is dried or at low relative humidity.

This discovery will be useful in providing an effective alternative means to overcome the existing shortcomings and limitations of air ionizers in the current device miniaturization market trend where ESD control mitigation techniques becoming more and more challenging. The invention will provide an alternative useful solution in a real life ESD sensitive manufacturing environment.

FIG. 2 is a decomposition diagram showing a humid air delivery apparatus according to a preferable embodiment of the present application. In the present embodiment, the humid air delivery apparatus 200 comprises an air nozzle 220 with a flat mouth 222 and a delivery tubing 210 for connecting the humid air generator 100 and the air nozzle 220. The outer edges of the flat mouth 222 form the rectangular opening 221 facing the target object 400. Two mounting slots 223 are made at opposite inner long sides of the rectangular opening 221.

In the present application, the conductive means 230 comprises a strip 231 attached across the opening 221 by inserting into the mounting slots 223, and metal threads 232 attached to the strip 231 and bended to form multiple small loops contacting the target object 400 and connecting the grounded apparatus 300. Of course, the metal threads 232 are soft enough as not to damage the target object 400. In a further embodiment, the metal threads 232 cannot be bended, and have a brush-like structure.

In another preferable embodiment, the metal threads 232 can be replaced by soft metal sheets. In a preferable embodiment, the metal threads 232 or the soft metal sheets are made of soft stainless-steel tinsel wires or sheet. Of course, other conductive threads can also be employed. The present embodiment is more preferable when the target object is a thin film/web. In a more preferable embodiment, the strip 231 also can be made by conductive materials. It also should be noted that, although just one conductive means 230 is shown in FIG. 2, there also can be more conductive means 230, which depends on the actual requirements. One skilled in the art should notice that the strip 231 could be arranged across the opening 221 by other ways, such as fixed with bolts, screws or adhesive.

FIG. 3 is a decomposition diagram showing a humid air delivery apparatus according to a further preferable embodiment of the present application. FIG. 3 is similar as that in FIG. 2, the difference between them is the design of the conductive means 230. In this embodiment, the humid air delivery apparatus 200 also comprises an air nozzle 220 with a flat mouth 222 and a delivery tubing 210 for connecting the humid air generator 100 and the air nozzle 220. The outer edges of the flat mouth 222 form the rectangular opening 221 facing the target object 400. Two mounting slots 223 are made at opposite inner long sides of the rectangular opening 221.

Furthermore, the conductive means 230 comprises a roller 234 attached across the opening 221 and metal threads 235 wrapping around the roller 234 to contact the target object 400 and connect the grounded apparatus 300. In the present application, the mounting axle 233 of the roller 234 is inserted into the mounting slots 223 for attachment to the opening 221. Preferably, the metal threads 235 wraps up the full surface of the roller 234 and the mounted roller 234 is rotatable. In a more preferable embodiment, the roller 234 also can be made by conductive materials. One skilled in the art should notice that the roller 234 could be arranged across the opening 221 by other ways, such as fixed with bolts, screws or adhesive.

By employing the humid air delivery apparatuses shown in FIGS. 2-3, similar results are obtained. When a humid air with a specified relative humidity of 60% to 95%, preferably from 75% to 90%, and more preferably from 85%-90% from the humid air generator is released at the opening of the humid air delivery apparatus and directed at the meeting point between the target object and the conductive means connecting the grounded apparatus, it is surprised to see the drop of more than 90% of the original static voltage after the target object was passed through and separated away from the conductive means. The discovery is surprising because no air ionizer has been used in neutralizing and cutting down the static charge.

FIG. 4 is a diagram showing a static charge reduction device according to a second embodiment of the present application. As shown in FIG. 4, the static charge reduction device can comprise two humid air delivery apparatuses 200 each connecting one humid air generator 100 and one grounded apparatus 300. In the present application, the two humid air delivery apparatuses 200 can be constructed according to any of the preceding embodiments, and they are arranged in parallel and placed in series along the target object 400. It should be noted that, the two humid air delivery apparatuses 200 can be the same or can be different. Furthermore, static charge reduction device can further comprise more humid air delivery apparatuses 200.

FIG. 5 is a diagram showing a static charge reduction device according to a third embodiment of the present application. As shown in FIG. 5, the static charge reduction device can comprise two humid air delivery apparatuses 200 both connecting one humid air generator 100 and each corresponding grounded apparatuses 300. In the present application, the two humid air delivery apparatuses 200 can be constructed according to any of the preceding embodiments, and they are arranged in parallel and placed in series along the target object 400. It should be noted that, the two humid air delivery apparatuses 200 can be the same or can be different. Furthermore, the static charge reduction device can further comprise more humid air delivery apparatuses 200 connecting the same or different humid air generator 100. In additional, the humid air delivery apparatuses 200 can be connected with just one or different grounded apparatus 300. By employing the embodiments in FIGS. 4-5, more options of static charge reduction means can be utilized for flexibility of application.

FIG. 6 is a diagram showing a static charge reduction device according to a fourth embodiment of the present application. In the present application, the static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus.

In the embodiment referred by FIG. 6, the source of humid medium is water. Accordingly, the humid medium generator is a container 500 filled with water 510, the humid medium delivery apparatus comprises a water delivery structure 610 and a water delivery medium 620 with one end wrapped up on the water delivery structure 610 and other end contacting the conductive means 230. As shown in FIG. 6, the lower portion of the water delivery structure 610 is immersed into the water 510 and an upper portion of the water delivery structure 610 is arranged above the water 510 such that the water 510 in the container 500 is delivered through the water delivery medium 620, the conductive means 230 and the target object 400 successively for static charge reduction through capillary action.

In the present application, the container 500 can be made of any material in any shape. For example, it can be a round glass container or oval ceramic vessel and so on. The water delivery structure 610 also can be a round, oval or square pillar with one end immersed in the water 510, while the other end is above the water 510 to facilitate water delivery through capillary action. Preferably, the water delivery structure 610 is a cone-shape-like cylindrical roll. The water delivery medium 620 can be any material in any shape which is capable of migrating water by through capillary action, such as cloth, tissue, paper and so on. In a preferable embodiment, the water delivery medium 620 can be cloth. In the present embodiment, the water 510 is supplied to the conductive means 230 through the placing of the wet water delivery medium 620 over the upper portion of the conductive means 230, such that water 510 is transferred to the conductive means 230 and then migrating downwards to the lower portion of the conductive means 230.

In a simple embodiment of the present application, the water delivery medium 620 can just be a cloth strip whose one end wrapped up on the water delivery structure 610 and other end contacting the conductive means 230. The cloth strip is made wet by soaping/dipping a portion of the water delivery structure 610 wrapped up with dry cloth into the container 500 such that the water 510 in the container 510 will migrate upwards above the water level through capillary action onto the dry cloth above the water level.

In a more preferable embodiment of the present application, as shown in FIG. 6, the water delivery structure 610 is a cylindrical roll and a lower portion of the cylindrical roll is immersed into the water 510. The water delivery medium 620 comprises a first water delivery medium portion 621 wrapping up from the lower portion of the cylindrical roll to the upper portion of the cylindrical roll, a second water delivery medium portion 622 wrapping the first water delivery medium on the upper portion of the cylindrical roll, and a third water delivery medium portion 623 connecting the second water delivery medium portion 622 and the conductive means 230. In this specific embodiment, the conductive means 230 comprises a horizontal mounting structure 236 and conductive elements 237 arranged on a lower edge of the horizontal mounting structure 236. The third water delivery medium portion 623 is attached on horizontal mounting structure 236 such that the water 510 can be delivered to the conductive elements 237. In the preferable embodiment, the width of the third water delivery medium portion 623 is a little broader than that of the horizontal mounting structure 236, such that the lower edge of the third water delivery medium portion 623 can be in contact with the conductive elements 237.

Surprisingly, when a well-controlled tiny amount of water is supplied to the conductive elements 237 (that is, to make the conductive elements 237 wet without water dripping from the conductive elements 237), it is discovered that there is a great difference in the further drop of the static charge voltage, comparing to without water supply to the conductive elements 237. Typically, when a moving polyethylene film unwind from a roll with a high static voltage of 20,000V and passes through the wet conductive elements 237, the static voltage drops to a very low level of less than 500V static voltage. Typically, a 97.5% drop of static voltage is observed.

It is not very well understood why such phenomena is observed. It is probably due to the optimization of the ionization and grounding effect when the vicinity surrounding the wet conductive elements 237 achieves a very high relative humidity with water vapor emitted from the wet tinsel thread in close proximity to the polyethylene film's surface.

In a similar preferable embodiment of the present application, the static charge reduction device further comprises a humid air generator for generating a humid air with a specified relative humidity and a humid medium delivery apparatus for delivering the humid medium to a target object. Similar technical effect can be obtained. Equally surprising, no matter the humid air current is added or removed leaving only the wet conductive elements, an unexpected drastic drop in the static voltage is observed. The drop in static voltage now even far exceeded the amount of drop with the humid air blowing but without the wet conductive elements. This is interesting because with the well-controlled tiny amount of water being migrated/supplied to the conductive elements, it changes the outcome and achieving a much bigger static charge reduction capability irrespective whether there is humid air blowing or not.

In additional, we also discovered that when a water saturated wet cloth is placed on the conductive elements at ambient relative humidity in the absence of humid air current blowing at it, water drips at the bottom ends of the conductive elements. However, when the humid air is blowing over the exposed conductive elements, the conductive elements completely stop dripping. In other words, to prevent the dripping of the wetted conductive elements, a technical solution is to let the conductive elements be continuously blown with a humid air current instead of just leaving it to the ambient atmosphere without humid air blowing at it.

In the present embodiment, the conductive elements 237 can be metal threads 91 bended to form multiple small loops 92 contacting the target object. Optionally, the metal thread 91 is typically made from stainless fibers in staple length or continuous filament that are spun into single yarns and then two or more of these yarns are plied together to make the tinsel thread. Optionally, the metal thread 91 of the small loop 92 is incorporated with a tiny protective helical metal coil 93 as shown in FIG. 9. This is to protect the metal thread from excessive rubbing during use to prevent or eliminate the frequent replacement of the tinsel thread due to its fast wear and tear in continuous use. Such tiny protective coil also prevents the sloughing of the metal thread to so that the current application is suitable for use in a very clean high-end cleanroom environment.

FIG. 7 is a diagram showing a static charge reduction device according to a fifth embodiment of the present application. The embodiment is FIG. 7 is similar as that in FIG. 6, and their difference lies in that the water delivery structure 600 is further provided with a retractable mechanism 640 for retracting the water delivery medium 620, and the conductive means 230 comprises two horizontal mounting structures 231 arranged horizontally such that conductive elements 232 arranged on the lower edge of the two horizontal mounting structures 231 are in contact with the target object passing through horizontally. In this embodiment, the water delivery medium has a bilayer structure. The use of a retractable mechanism 640 is preferred. The main purpose of a retractable mechanism 640 is to facilitate the pre-wetting of the cylindrical roll of dry water delivery medium for instant use to save time without the need to wait for the water from the water container to travel along the whole length of the dry cloth due to the slow capillary action by nature. Optionally, the two (2) or more layers of the water delivery medium are used in supplying to two (2) or more horizontal mounting structures 231 respectively to further improve the static charge reduction effectiveness. In the present application, the retractable mechanism 640 can be arranged in any type or manner, and it can be manual or automatic.

FIG. 8 is a diagram showing a static charge reduction device according to a sixth embodiment of the present application. The embodiment is FIG. 8 is similar as that in FIG. 7, and their difference lies in that the two horizontal mounting structures 231 are arranged in a titled manner such that conductive elements 232 arranged on the lower edge of the two horizontal mounting structures 231 contact the target object 400 passing through vertically. Such placement of tilted horizontal mounting structures 231 provides more choices of applications especially when a highly charged film travels vertically from top to down or from down to top in optimizing the application and usage of the present application. In a preferable embodiment of the present application, such tilted angle can be adjusted.

The foregoing description of the exemplary embodiments of the application has been presented only for the purposes of illustration and description and is not intended to be exhaustive or to limit the application to the precise forms disclosed. Many modifications and variations are possible in light of the above teaching.

The embodiments were chosen and described in order to explain the principles of the application and their practical application so as to activate others skilled in the art to utilize the application and various embodiments and with various modifications as are suited to the particular use or contemplated use effect. Alternative embodiments will become apparent to those skilled in the art to which the present application pertains without departing from its spirit and scope. Accordingly, the scope of the present application is defined by the appended claims rather than the foregoing description and the exemplary embodiments described therein.

1. A static charge reduction device comprising a humid medium generator for generating a humid medium with a specified relative humidity, a humid medium delivery apparatus for delivering the humid medium to a target object, a grounded apparatus connecting the humid medium delivery apparatus and ground, and a conductive means which both contacting the target object and connecting the grounded apparatus; wherein the humid medium delivery apparatus, the conductive means and the target object are arranged successively along a delivery path of the humid medium, such that the humid medium is delivered through the humid medium delivery apparatus, the conductive means and the target object successively for static charge reduction.

2. The static charge reduction device according to claim 1, wherein the humid medium generator comprises a humid air generator for generating a humid air with a specified relative humidity, the humid medium delivery apparatus comprises a humid air delivery apparatus having an opening facing the target object for directing the humid air to the target object, and the conductive means comprises a mounting structure arranged in the opening and conductive elements arranged on the mounting structure, wherein the conductive elements are contacting the target object and connecting the grounded apparatus.

3. The static charge reduction device according to claim 2, wherein the humid air delivery apparatus comprises an air nozzle with a flat mouth whose outer edge forms the opening facing the target object.

4. The static charge reduction device according to claim 3, wherein the mounting structure comprises a strip arranged across the opening, and the conductive elements are metal threads attached to the strip and bended to form multiple small loops contacting the target object.

5. The static charge reduction device according to claim 3, wherein two mounting slots are made at opposite inner sides of the opening and the strip is inserted into the mounting slots for attachment to the opening.

6. The static charge reduction device according to claim 3, wherein the mounting structure comprises a roller arranged across the opening and the conductive elements are metal threads wrapping around the roller and in contact with the target object.

7. The static charge reduction device according to claim 6, wherein the mounting structure further comprises two mounting slots made at opposite inner sides of the opening and a mounting axle of the roller is inserted into the mounting slots for attachment to the opening.

8. The static charge reduction device according to claim 3, wherein the mounting structure comprises a strip arranged across the opening, and the conductive elements are soft metal sheets attached to the strip and contacting the target object.

9. The static charge reduction device according to claim 2, wherein humid air delivery apparatus further comprises a delivery tubing for connecting the humid air generator and the flat mouth.

10. The static charge reduction device according to claim 1, wherein the humid medium generator comprises a container filled with water, the humid medium delivery apparatus comprises a water delivery structure and a water delivery medium with one end wrapped up on the water delivery structure and other end contacting the conductive means, wherein a lower portion of the water delivery structure is immersed into the water and an upper portion of the water delivery structure is arranged above the water such that the water in the container is delivered through the water delivery medium, the conductive means and the target object successively for static charge reduction through capillary action.

11. The static charge reduction device according to claim 10, wherein the water delivery structure is a cylindrical roll and a lower portion of the cylindrical roll is immersed into the water, the water delivery medium comprises a first water delivery medium portion wrapping up from the lower portion of the cylindrical roll to the upper portion of the cylindrical roll, a second water delivery medium portion wrapping the first water delivery medium on the upper portion of the cylindrical roll, and a third water delivery medium portion connecting the second water delivery medium portion and the conductive means.

12. The static charge reduction device according to claim 11, wherein the conductive means comprises a horizontal mounting structure and conductive elements arranged on a lower edge of the horizontal mounting structure, and the third water delivery medium portion is attached on horizontal mounting structure such that the water can be delivered to the conductive elements.

13. The static charge reduction device according to claim 12, wherein the conductive elements are metal threads bended to form multiple small loops contacting the target object, and the metal thread is incorporated with a tiny protective helical metal coil.

14. The static charge reduction device according to claim 11, wherein the water delivery structure is further provided with a retractable mechanism for retracting the water delivery medium.

15. The static charge reduction device according to claim 14, wherein the conductive means comprises two horizontal mounting structures arranged horizontally or in a titled manner such that conductive elements arranged on the lower edge of the two horizontal mounting structures are in contact with the target object passing through horizontally or vertically, and the water delivery medium has a bilayer structure.

16. The static charge reduction device according to claim 10, wherein further comprises a humid air generator for generating a humid air with a specified relative humidity and a humid medium delivery apparatus for blowing the humid air to the conductive means.
